(19) United States
(12) Patent Application Publication
(10) Pub. No.: US 2026/0056453 A1
(43) Pub. Date: Feb. 26, 2026

(54) METHOD FOR ASSISTING THE MANUAL ADJUSTMENT OF PROJECTOR AND PROJECTOR

(71) Applicant: Coretronic Corporation, Hsin-Chu (TW)

(72) Inventors: Ching-Feng HSIEH, Hsin-Chu (TW); Hui-Chung HUNG, Hsin-Chu (TW)

(21) Appl. No.: 19/251,703

(22) Filed: Jun. 26, 2025

(30) Foreign Application Priority Data
Aug. 26, 2024 (CN) 2024111779431

(51) Int. Cl. G03B 21/14

(52) U.S. Cl. CPC G03B 21/147

(57) ABSTRACT

The present disclosure provides a method for assisting the manual adjustment of projector and a projector. The projector comprises a projection optical engine, a sensor and a controller. The controller performs the following steps: receiving a plurality of detection data continuously and in real time from the sensor; determining whether a current detection data at a current time is the same as a past detection data at a previous time, wherein the detection data comprises the current detection data and the past detection data; controlling the projection optical engine to project a status image when the current detection data is different from the past detection data, wherein the status image comprises a current angle data, which is obtained based on the plurality of detection data; and not controlling the projection optical engine to project the status image when the current detection data is the same as the past detection data.

### CROSS-REFERENCE TO RELATED APPLICATION

This application claims the priority benefit of Chinese Patent Application Serial Number 202411177943.1, filed on Aug. 26, 2024, the full disclosure of which is incorporated herein by reference.

### BACKGROUND

### Technical Field

The present disclosure relates to the technical field of adjustment methods, and particularly to a method for assisting the manual adjustment of a projector and a projector.

### Related Art

When using a projector, a user adjusts a size or a shape of a projection image projected by the projector by moving the projector to ensure the projection of a rectangular projection image that fits the on-site environment so that viewers can view the projection image.

However, when using an ultra-short-throw projector, the user may want to adjust the projection image of the ultra-short-throw projector, and because a distance between the projection image and the user is short and the projection image is large, the user needs to move away from the projection image and the projector every time the user adjusts the projector. Then the user can determine from an appropriate viewing point whether the projection image is horizontal. At this time, if the projection image is not horizontal, the user needs to move close to the projector so as to adjust the projector and then move away from the projector after adjusting the projector so as to again determine whether the projection image is horizontal. Therefore, if the projection image is to be adjusted to a horizontal orientation, the user must move back and forth between the projector and the viewing point many times, which makes the operation inconvenient and time-consuming.

Thus, the existing technology requires further improvement.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In view of the above-mentioned deficiencies in the prior art, the main purpose of the present invention is to provide a method for assisting the manual adjustment of a projector and a projector, by projecting the status information of the projector to determine whether the projector needs to be adjusted such that the user does not need to move forward or backward, thereby improving the convenience and efficiency of operation.

To achieve one or part or all of the above purposes or other purposes, an embodiment of the present invention comprises a method for assisting the manual adjustment of a projector, and the projector comprises a projection optical engine, a sensor and a controller. The controller is electrically connected to the projection optical engine and the sensor. The method comprises the following steps: receiving a plurality of detection data continuously and in real time from the sensor; determining in real time whether a current detection data at a current time is the same as a past detection data at a previous time, wherein the plurality of detection data comprise the current detection data and the past detection data; controlling the projection optical engine to project a status image when the current detection data is different from the past detection data, wherein the status image comprises a current angle data and the current angle data is obtained based on the plurality of detection data; and not controlling the projection optical engine to project the status image when the current detection data is the same as the past detection data.

In order to achieve the above-mentioned purpose, another technical means adopted by the present disclosure is mainly that the projector comprises a projection optical engine, a sensor and a controller, wherein the sensor is used continuously and in real time to transmit a plurality of detection data to the controller, the controller is electrically connected to the projection optical engine and the sensor, and the controller is configured to perform the following steps: receiving the plurality of detection data detected by the sensor continuously and in real time; determining in real time whether a current detection data at a current time is the same as a past detection data at a previous time, wherein the plurality of detection data include the current detection data and the past detection data; controlling the projection optical engine to project a status image when the current detection data is different from the past detection data, wherein the status image includes a current angle data and the current angle data is obtained based on the plurality of detection data; and not controlling the projection optical engine to project the status image when the current detection data is the same as the past detection data.

By means of the above-mentioned method for assisting the manual adjustment of a projector and the above-mentioned projector, when the controller determines that the current detection data is different from the past detection data, the controller controls the projection optical engine to project the status image so as to provide the user with the assistance of the status image to adjust a position of the projector. In this way, the user does not need to move to a specific viewing point after each adjustment of the projector in order to fully see the effect of the projected image and then adjust the position of the projector again, thereby improving the convenience and efficiency of operation.

Other objectives, features and advantages of the present invention will be further understood from the further technological features disclosed by the embodiments of the present invention, wherein there are shown and described preferred embodiments of this invention, simply by way of illustration of modes best suited to carry out the invention.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows, taken in conjunction with the accompanying drawings in which:

FIG. 1 is a block diagram of a projector according to an embodiment of the present invention.

FIG. 2 is a block diagram of a projector according to another embodiment of the present invention.

FIG. 3 and FIG. 4 are schematic diagrams of a principle of an inertial sensor.

FIG. 5 and FIG. 6 are schematic diagrams of angle calculation of a time-of-flight sensor.

FIG. 7 is a flowchart of a method for assisting the manual adjustment of a projector according to the present disclosure.

FIG. 8 is a flowchart of a method for assisting the manual adjustment of a projector according to the present disclosure.

FIG. 9 is a flowchart of a method for assisting the manual adjustment of a projector according to the present disclosure.

FIG. 10 is a flowchart of a specific method for assisting the manual adjustment of a projector according to the present disclosure.

FIG. 11 is a flowchart of a method for assisting the manual adjustment of a projector according to the present disclosure.

FIG. 12 is a flowchart of a method for assisting the manual adjustment of a projector according to the present disclosure.

FIG. 13 is a flowchart of a specific method for assisting the manual adjustment of a projector according to the present disclosure.

FIG. 14a is a schematic diagram illustrating an example of a roll angle according to the present disclosure.

FIG. 14b is a schematic diagram of the roll angle of FIG. 14a from the same viewing angle.

FIG. 15a is a schematic diagram illustrating an example of a yaw angle according to the present disclosure.

FIG. 15b is a schematic diagram of another viewing angle of the yaw angle of FIG. 15a.

FIG. 16a is a schematic diagram illustrating an example of a pitch angle according to the present disclosure.

FIG. 16b is a schematic diagram of the pitch angle of FIG. 16a from another viewing angle.

FIG. 17 is a schematic diagram of a reminder image mentioned in FIG. 12 and FIG. 13.

### DETAILED DESCRIPTION OF THE EMBODIMENTS

It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein, are used broadly and encompass direct and indirect connections, couplings, and mountings.

The following descriptions will be combined with the drawings in the embodiments of the present invention to clearly and completely present the technical solutions in the embodiments of the present invention. Obviously, the described embodiments are some of the embodiments of the present invention and not all of the embodiments. Based on the embodiments in the present disclosure, all other embodiments obtained by ordinary technicians in this field without creative work are within the scope of protection of the present invention.

The aforementioned and other technical contents, features and effects of the present invention will be clearly presented in the following detailed description of a preferred embodiment with reference to the drawings. The directional terms mentioned in the following embodiments, such as up, down, left, right, front, back, etc., are only the directions in the attached drawings. Therefore, the directional terms used are used to illustrate and not to limit the present disclosure.

Regarding the definitions of the current time and the previous time of the present invention, the previous time is the previous moment relative to the current time. The current time in each step represents the time when the current step is being performed, so the previous time in each step is also the moment immediately previous to the moment when the current step is being performed. Therefore, the data received at each current time and the previous time will be different or the same.

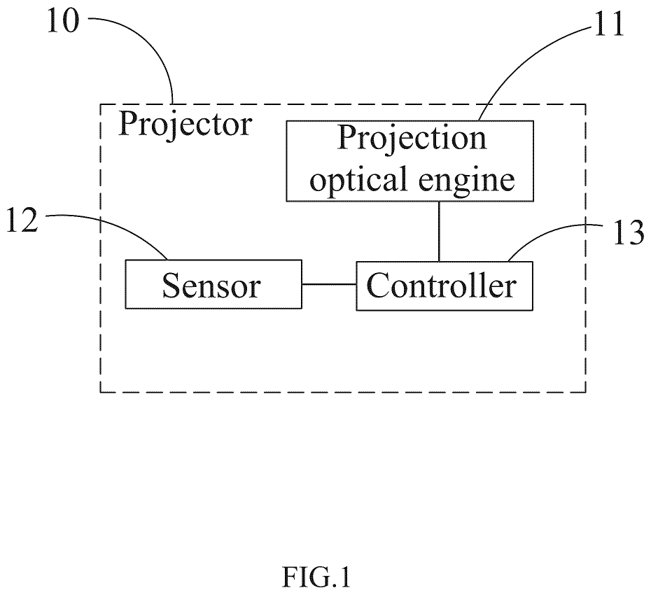

FIG. 1 is a block diagram of a projector according to an embodiment of the present invention. As shown in FIG. 1, the projector 10 of the present invention comprises a projection optical engine 11, a sensor 12 and a controller 13. The controller 13 is electrically connected to the projection optical engine 11 and the sensor 12, respectively. The sensor 12 can continuously and in real time detect a plurality of detection data. The sensor 12 can continuously and in real time transmit a plurality of detection data to the controller 13 so that the controller 13 can determine whether to cause the projection optical engine 13 to project a status image according to the plurality of detection data. In the embodiment, the sensor 12 can continuously and in real time detect data at each time interval, wherein a unit time may be, for example, the time interval between the current time and the previous time. In another embodiment, the time interval may be the same or different. In the embodiment, the sensor 12 may be, for example, an inertial sensor and/or a distance sensor, wherein the inertial sensor is configured to detect a plurality of angle data of the plurality of detection data, a current detection data is a current angle data detected by the inertial sensor when the inertial sensor detects the projector 10 at the current time, and a past detection data is a past angle data detected by the inertial sensor when the inertial sensor detected the projector 10 at the previous time. The distance sensor is configured to detect a plurality of distance data of the plurality of detection data, the current detection data is a current distance data detected by the distance sensor when the distance sensor detects a distance between the projector 10 and the projection image at the current time, and the past detection data is a past distance data detected by the distance sensor when the distance sensor detected the distance between the projector 10 and the projection image at previous time. Specifically, the inertial sensor is, for example, a gyroscope or an acceleration sensor, and the acceleration sensor is, for example, an integrated circuit of the LIS2DH12 model, and the distance sensor is, for example, a time of flight (ToF) sensor.

Specifically, the projection optical engine 11 comprises an illumination module, a light valve and a projection lens. The illumination module is used to provide a light beam. The illumination module includes at least one light emitting diode (LED), at least one laser diode (LD), or a combination thereof, and also includes optical components for transmitting the light beam or/and changing the path of the light beam, such as lenses, prisms, reflectors, and light splitting components. The light valve is arranged in the transmission path of the light beam to convert the light beam into an image beam. The light valve is, for example, a reflective light modulator such as a liquid crystal on silicon panel (LCoS panel), a digital micro-mirror device (DMD), or in some embodiments, it can also be a transmissive light modulator such as a transparent liquid crystal panel, an electro-optical modulator, a magneto-optical modulator, or an acousto-optic modulator (AOM). The projection lens is arranged in the transmission path of the image beam to project the image beam out of the projector 10. The projection lens is, for example, a combination of one or more optical lenses with refractive power, such as various combinations of non-planar lenses such as a biconcave lens, biconvex lens, concave-convex lens, convexo-concave lens, plano-convex lens, or plano-concave lens.

In addition, the controller 13 may be, for example, a central processing unit (CPU) or other programmable general-purpose or special-purpose micro control unit (MCU), microprocessor, digital signal processor (DSP), programmable controller, application specific integrated circuit (ASIC), graphics processing unit (GPU), arithmetic logic unit (ALU), complex programmable logic device (CPLD), field programmable gate array (FPGA), or any other type of integrated circuit or similar component or a combination of the above components.

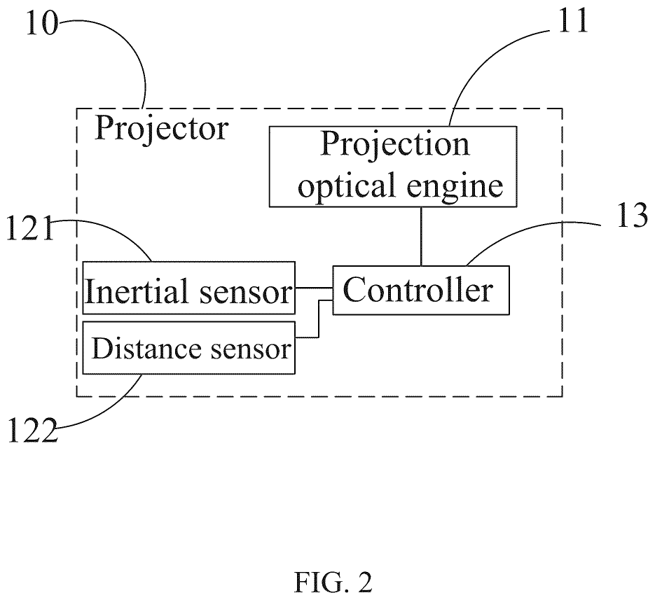

FIG. 2 is a block diagram of a projector according to another embodiment of the present invention. The projector of this embodiment is substantially the same as the projector in FIG. 1, except for the following: As shown in FIG. 2, the sensor 12 includes an inertial sensor 121 and a distance sensor 122. The operation of the inertial sensor 121 and the distance sensor 122 is substantially the same as that of the embodiment in FIG. 1.

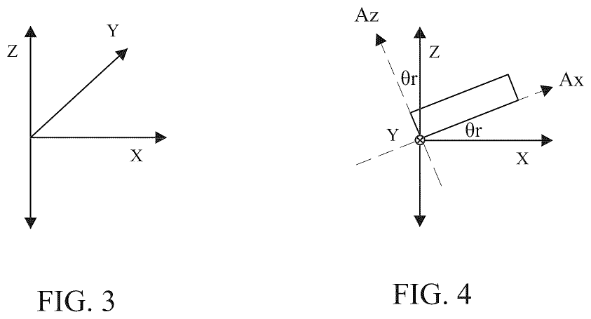

FIG. 3 and FIG. 4 are schematic diagrams of the principle of the inertial sensor. The inertial sensor in this disclosure is, for example, an acceleration sensor. As shown in FIG. 3, in a coordinate system of the acceleration sensor, a first coordinate axis X, a second coordinate axis Y and a third coordinate axis Z are orthogonal to each other. Specifically, as shown in FIG. 4, assuming that the box represents the projector 10, when the projector 10 rotates by an angle θr with the second coordinate axis Y as the axis, the angle θr is obtained in the following manner: The first coordinate axis X in the corresponding coordinate system of the acceleration sensor will produce an acceleration change Ax, and the third coordinate axis Z in the corresponding coordinate system will produce an acceleration change Az. The angle θr can be further calculated by trigonometric functions according to the acceleration change Ax and the acceleration change Az. By analogy, when the projector 10 rotates by an angle θp (not shown) with the first coordinate axis X as the axis, the angle θp (not shown) can also be calculated by trigonometric functions in the above manner, and when the projector 10 rotates by an angle θy (not shown) with the third coordinate axis Z as the axis, the angle θy (not shown) can also be calculated by trigonometric functions in the above manner. In the embodiment, a direction of gravity is, for example, the −Z direction parallel to the third coordinate axis Z.

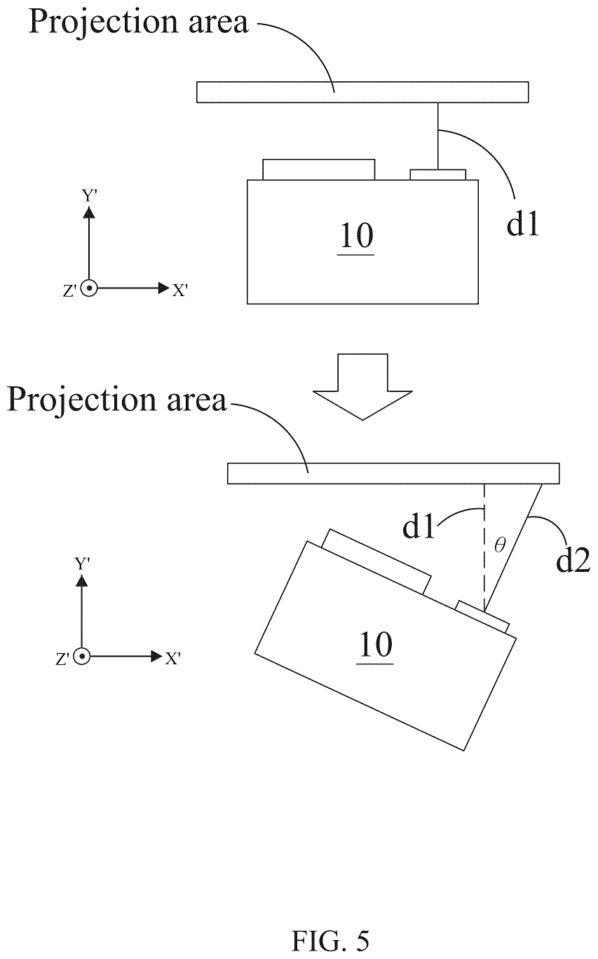

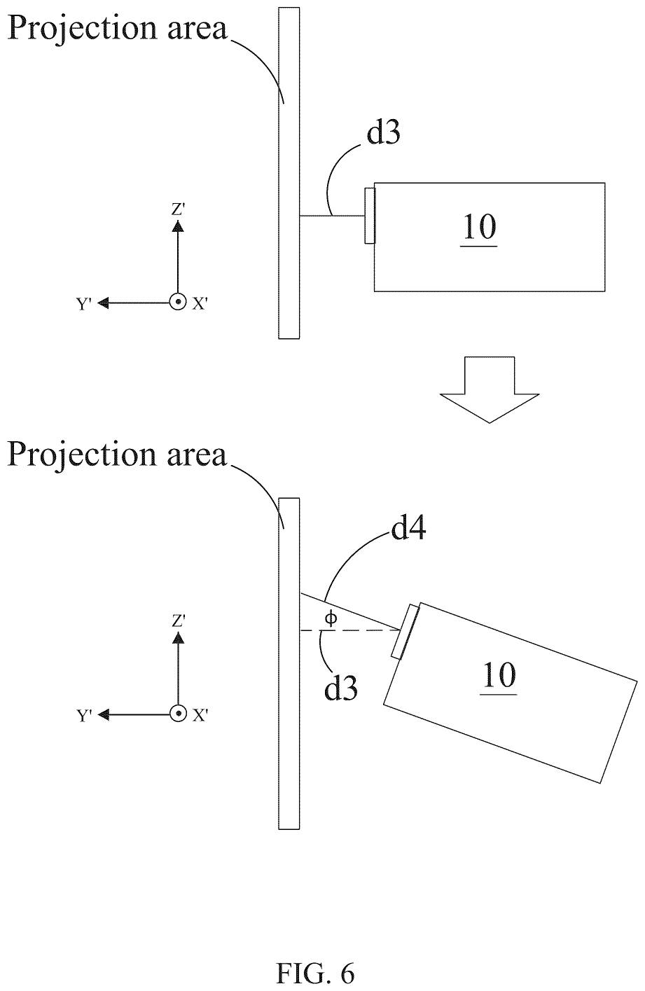

FIG. 5 and FIG. 6 are schematic diagrams of angle calculation of a time-of-flight sensor. In the present embodiment, the distance sensor 122 is, for example, a time-of-flight sensor, and the distance sensor 122 comprises a transmitter (not shown) and a receiver (not shown). The transmitter is configured to emit light to a projection area. After the light reaches the projection area, the reflected light is received by the receiver. The controller 13 calculates a time difference between when the transmitter emits the light and when the receiver receives the light. Then the controller 13 or the distance sensor 122 calculates a distance data according to the speed of light and the time difference.

As shown in FIG. 5, a past distance data detected by the distance sensor 122 at the previous time is a first distance data d1, and a current distance data detected by the distance sensor 122 at the current time is a second distance data d2. The controller 13 calculates an angle θ between the first distance data d1 and the second distance data d2 by a trigonometric function according to the first distance data d1 and the second distance data d2. It should be noted that the first coordinate axis X′, the second coordinate axis Y′ and the third coordinate axis Z′ corresponding to the embodiment can be used to understand the relative relationship between the projector 10 and the projection area.

As shown in FIG. 6, the past distance data detected by the distance sensor 122 at the previous time is a third distance data d3, and the current distance data detected by the distance sensor 122 at the current time is a fourth distance data d4. The controller 13 calculates an angle φ between the third distance data d3 and the fourth distance data d4 by a trigonometric function according to the third distance data d3 and the fourth distance data d4. Similarly, the first coordinate axis X′, the second coordinate axis Y′ and the third coordinate axis Z′ correspondingly illustrated in the embodiment can be used to understand the relative relationship between the projector 10 and the projection area.

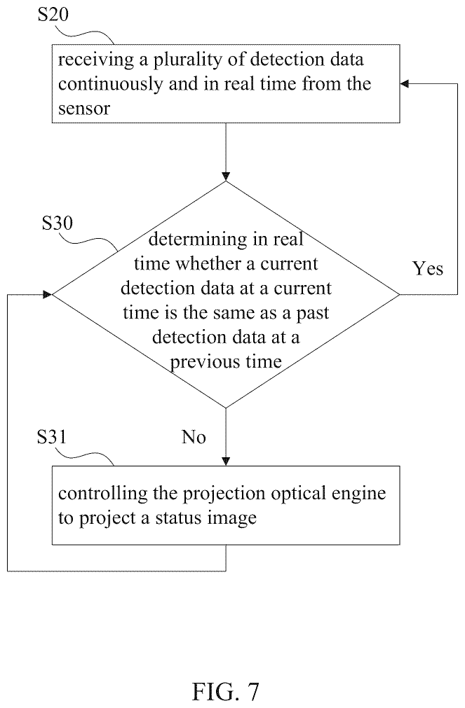

FIG. 7 is a flowchart of a method for assisting the manual adjustment of a projector according to the present disclosure. Referring to FIG. 7 and FIG. 1, the method for assisting the manual adjustment of a projector is that the controller 13 performs the following steps:
receiving a plurality of detection data continuously and in real time from the sensor 12 (S20).
determining in real time whether a current detection data at a current time is the same as a past detection data at a previous time, wherein the plurality of detection data comprise the current detection data and the past detection data (S30).
controlling the projection optical engine to project a status image when the current detection data is different from the past detection data, wherein the status image comprises a current angle data and the current angle data is obtained based on the plurality of detection data (S31).
not controlling the projection optical engine 11 to project the status image when the current detection data is the same as the past detection data.

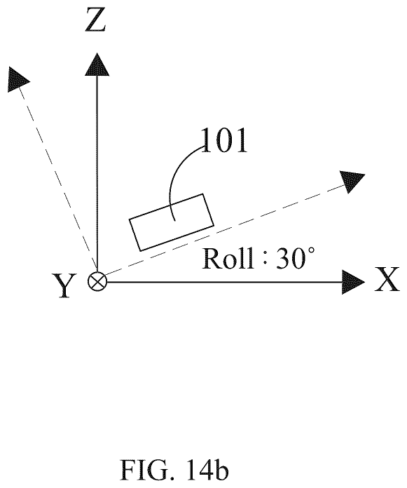

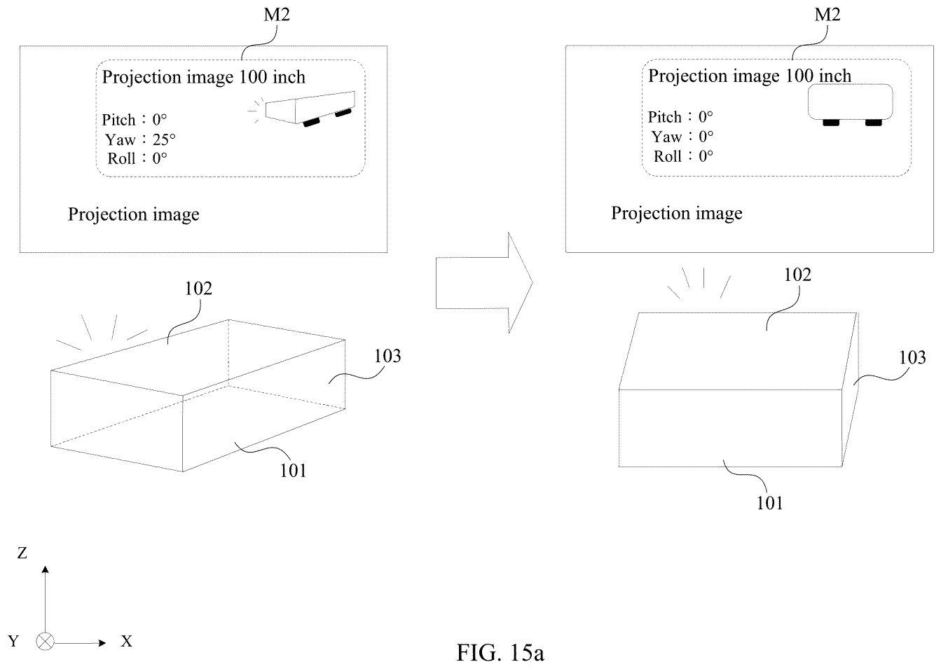

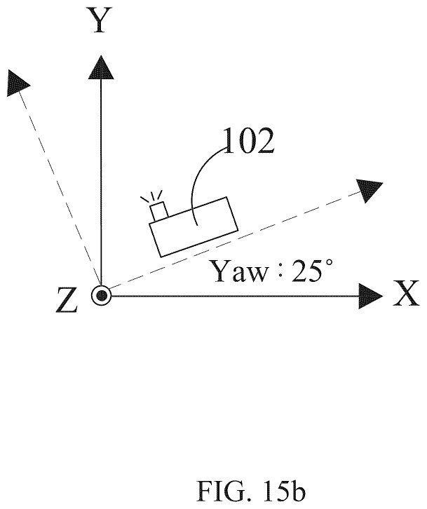

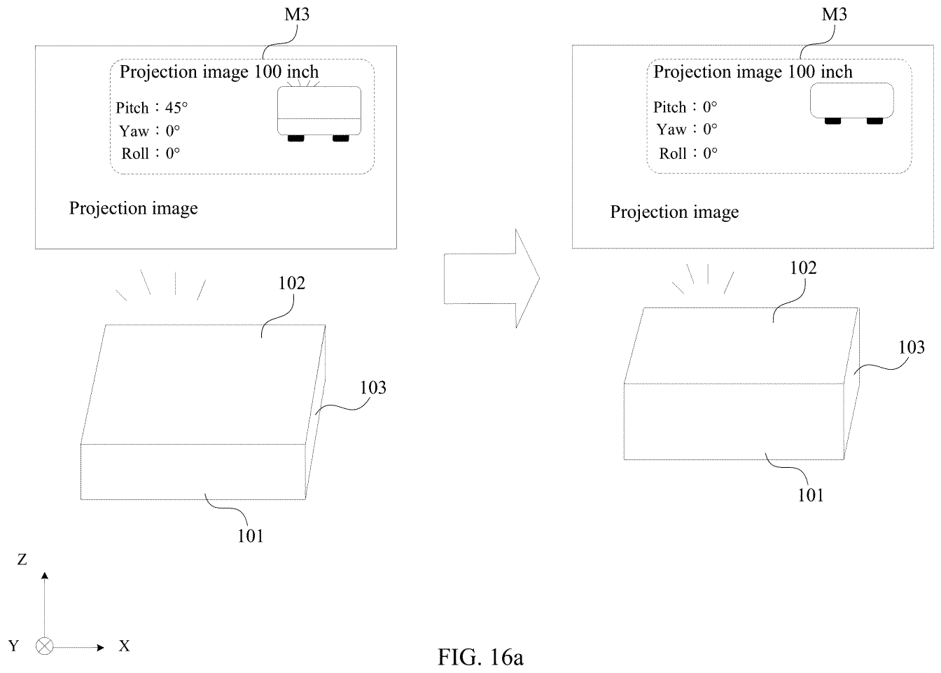

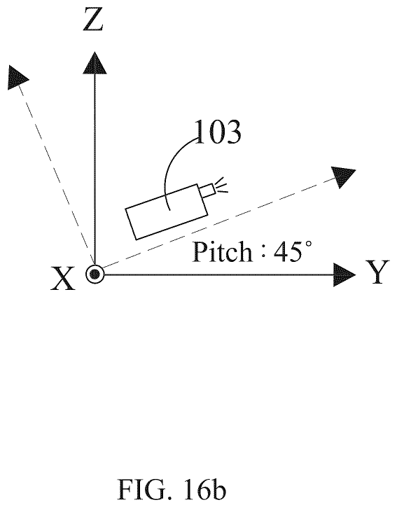

In the embodiment, when the projector 10 is in operation, the controller 13 may receive the plurality of detection data detected continuously and in real time from the sensor 12. In step S30, the past detection data is the detection data received at the previous time before the current detection data is received. In step S31, the status image comprises a current angle data, the current angle data may include a first angle data and a second angle data, and the first angle data and the second angle data are orthogonal to each other. For example, the first angle data and the second angle data may be obtained by calculating the distance data detected by the distance sensor 122; for illustration, the first angle data may be the angle θ mentioned in FIG. 5, and the second angle data may be the angle φ mentioned in FIG. 6. It should be noted here that the first angle data and the second angle data may also be the angle data detected by the inertial sensor 121; for illustration, the first angle data may be the angle θy as mentioned above. The projector 10 rotates by the angle θy with the third coordinate axis Z as the axis. The second angle data may be the angle θp as mentioned above. The projector 10 rotates by the angle θp with the first coordinate axis X as the axis. Furthermore, the current angle data may also include a third angle data, and the first angle data, the second angle data and the third angle data are orthogonal to each other. Specifically, the third angle data may be as described above, as the projector 10 rotates by an angle θr with the second coordinate axis Y as the axis. The first angle data (θ or θy) may be called a yaw angle, the second angle data (φ or θp) may be called a pitch angle, and the third angle data (θr) may be called a roll angle, as will be further described in conjunction with the subsequent FIG. 14, FIG. 15, and FIG. 16.

When the current detection data is different from the past detection data, the controller 13 controls the projection optical engine 11 to project the status image. The user can be located next to the projector 10 and adjust each position of the projector 10 according to an information (e.g., the current angle data) displayed on the status image. The user can adjust the projector 10 while monitoring the changes in the current angle data displayed on the status image until the subsequent projection image projected by the projector 10 is a rectangular image or an image size required by the user. In this way, the user does not need to move away from the projector 10 every time the position of the projector 10 is adjusted in order to fully view the projection image projected by the projector 10 so as to determine whether the projector 10 is projecting a rectangular image. In the prior art, when the user determines that the projector 10 is not projecting a rectangular image, the user must go to the location of the projector 10 to adjust the placement of the projector 10 again, and after adjusting the placement of the projector 10, the user must again move away from the projector 10. Therefore, the method and projector used in the present disclosure for assisting the manual adjustment of the projector can allow the user to directly adjust the placement of the projector 10 while standing beside the projector 10, and the user's operating convenience can be improved. In addition, the user can quickly adjust the position of the projector 10, thereby reducing time consumption.

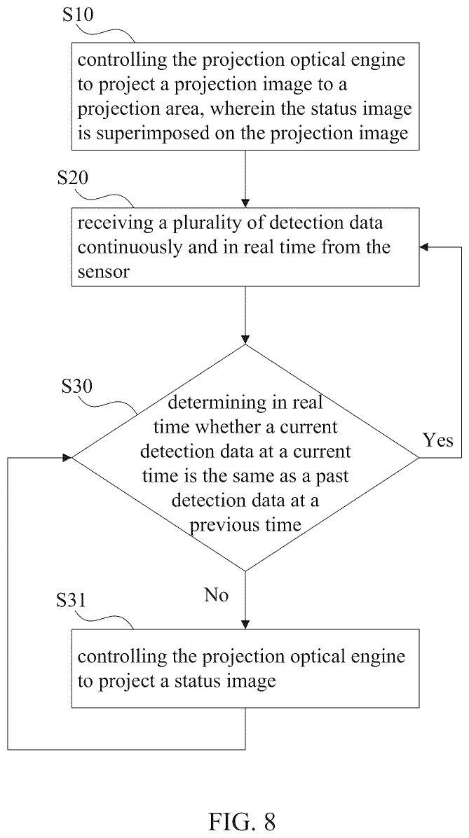

FIG. 8 is a flowchart of the method for assisting the manual adjustment of a projector according to the present disclosure. As shown in FIG. 8, the method of the embodiment is substantially the same as the method in FIG. 7. In the embodiment in FIG. 7, the projector 10 does not need to project any image before receiving the detection data of the sensor. In the embodiment in FIG. 8, before the controller 13 performs the step of “receiving a plurality of detection data continuously and in real time from the sensor (S20)”, the controller 13 performs the following steps in advance:
controlling the projection optical engine to project a projection image to a projection area, wherein the status image is superimposed on the projection image (S10). In the embodiment, the controller 13 controls the projection optical engine 11 to project an underlying image layer as the projection image, and then, when executing step S31, the controller 13 controls the projection optical engine 11 to project the status image superimposed on the underlying image layer, or when the controller 13 projects the projection image, the controller 13 also projects the status image at the same time. The other steps are the same as those in FIG. 7 and are not repeated.

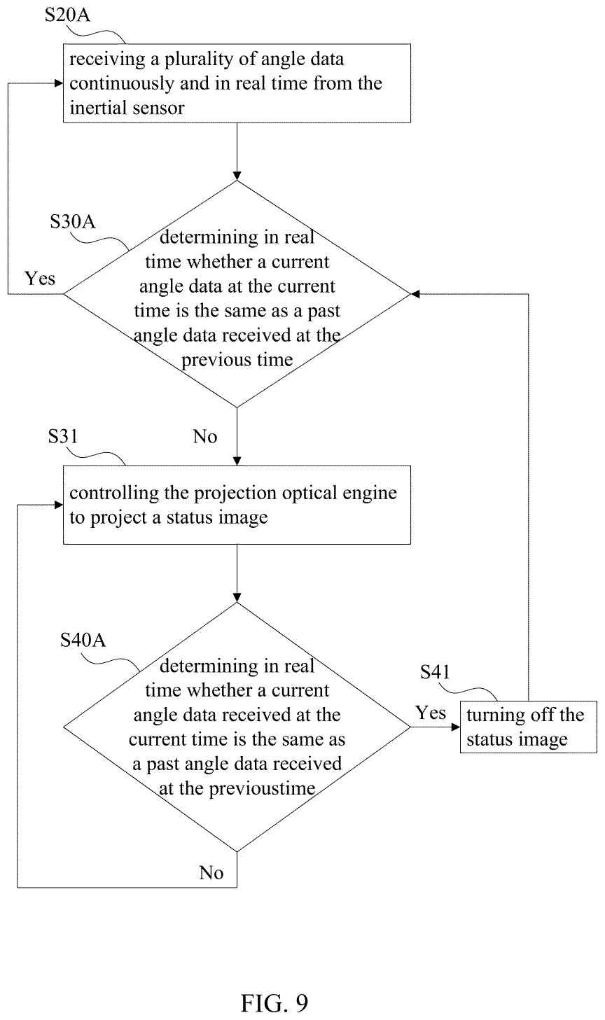

FIG. 9 is a flowchart of the method for assisting the manual adjustment of the projector of the present invention. Please refer to FIG. 9 and FIG. 2. In the embodiments in FIG. 1 and FIG. 2, it has been mentioned that the sensor 12 may only include the inertial sensor 121; that is, the projector 10 may not be equipped with the distance sensor 122. The plurality of detection data detected by the sensor 12 include a plurality of angle data detected by the inertial sensor 121. The current detection data detected by the sensor 12 includes the current angle data detected by the inertial sensor 121 at the current time, and the past detection data detected by the sensor 12 includes the past angle data detected by the inertial sensor 121 at the previous time. Therefore, the controller 13 of the present embodiment may perform the following steps:
receiving a plurality of angle data continuously and in real time from the inertial sensor 121 (S20A).
determining in real time whether a current angle data at the current time is the same as a past angle data received at the previous time (S30A).
controlling the projection optical engine 11 to project the status image when the current angle data is different from the past angle data (S31).
determining in real time whether a current angle data received at the current time is the same as a past angle data received at the previous time (S40A).
continuing to project the status image when the current angle data is different from the past angle data, wherein the status image includes the current angle data (that is, return to step S31).
turning off the status image when the current angle data is the same as the past angle data (S41) and continuing to determine in real time whether the current angle data is the same as the past angle data (that is, return to step S30A).

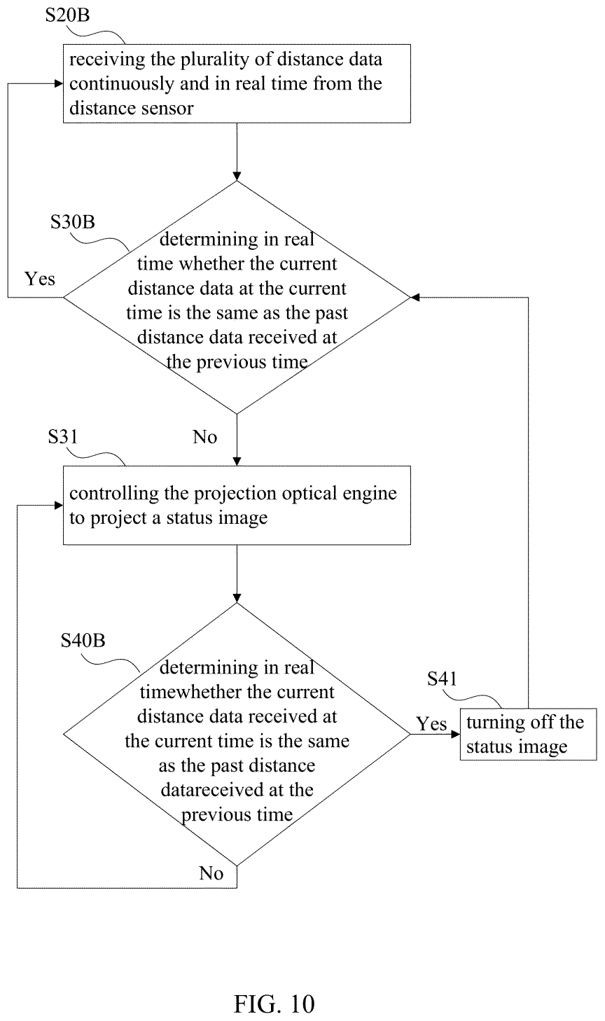

FIG. 10 is a flowchart of a specific method for assisting the manual adjustment of a projector according to the present disclosure. Please refer to FIG. 10 and FIG. 2. In the embodiments in FIG. 1 and FIG. 2, it has been mentioned that the sensor 12 may only include the distance sensor 122; that is, the projector 10 may not be equipped with the inertial sensor 121. The plurality of detection data detected by the sensor 12 include a plurality of distance data detected by the distance sensor 122. The current detection data detected by the sensor 12 includes the current distance data detected by the distance sensor 122 at the current time, and the past detection data detected by the sensor 12 includes the past distance data detected by the distance sensor 122 at the previous time. Therefore, the controller 13 of the embodiment may perform the following steps:
receiving the plurality of distance data continuously and in real time from the distance sensor 122 (S20B).
determining in real time whether the current distance data at the current time is the same as the past distance data received at the previous time (S30B).
controlling the projection optical engine 11 to project the status image when the current distance data is different from the past distance data (S31).
determining in real time whether the current distance data received at the current time is the same as the past distance data received at the previous time (S40B).
when the current distance data is different from the past distance data, the status image continues to be projected, wherein the current angle data included in the status image is obtained by calculation based on the current distance data and the past distance data (that is, returning to step S31). In the embodiment, after the distance sensor 122 obtains the current distance data and the past distance data, the distance sensor 122 transmits the current distance data and the past distance data to the controller 13, and the controller 13 calculates the current angle data by trigonometric functions based on the current distance data and the past distance data, and the angle θ and the angle φ mentioned in the above-mentioned FIGS. 5 and 6 can be referred to.
turning off the status image when the current distance data is the same as the past distance data (S41) and continuing to determine in real time whether the current distance data is the same as the past distance data (that is, returning to step S30B). In the embodiment, the controller 13 continues to determine in real time whether the current distance data and the past distance data are the same. When the current distance data is different from the past distance data, the status image continues to be projected.

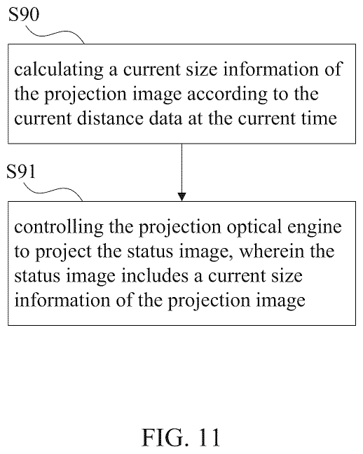

FIG. 11 is a flowchart of the method for assisting the manual adjustment of the projector of the present invention. Refer to FIG. 11 and FIG. 2. When the controller 13 detects the current distance data at the current time by the distance sensor 122, the method for assisting the manual adjustment of the projector also comprises the following steps:
calculating a current size information of the projection image according to the current distance data at the current time (S90).
controlling the projection optical engine to project the status image, wherein the status image includes a current size information of the projection image (S91).

In the embodiment, when the controller 13 detects the current distance data at the current time by the distance sensor 122, the controller 13 calculates an image width of the projection image according to the current distance data and a default projection ratio; that is, the controller 13 calculates the current size information of the projection image. In detail, when step S30B in FIG. 10 in the aforementioned embodiment is performed, the controller 13 determines whether the current distance data at the current time is the same as the past distance data received at the previous time. If the current distance data is different from the past distance data, the controller 13 controls the projection optical engine 11 to project the status image in step S31, the status image including the current size information calculated from the current distance data at the current time during step S30B and the default projection ratio. When in the method in the aforementioned embodiment step S40B is performed, the controller 13 determines whether the current distance data at the current time is the same as the past distance data received at the previous time. If the current distance data is different from the past distance data, the controller 13 controls the projection optical engine 11 to project the status image in step S31, the status image including the current size information calculated from the current distance data at the current time during step S40B and the default projection ratio. The current size information is obtained by the controller 13 by calculating the horizontal width of the projection image based on the current distance data in advance and the default projection ratio. The controller 13 calculates the height of the projection image based on the calculated horizontal width of the projection image and an aspect ratio of the projection image (e.g., the aspect ratio is 16:9). Subsequently, the controller 13 calculates the current size information of the projection image based on the Pythagorean theorem.

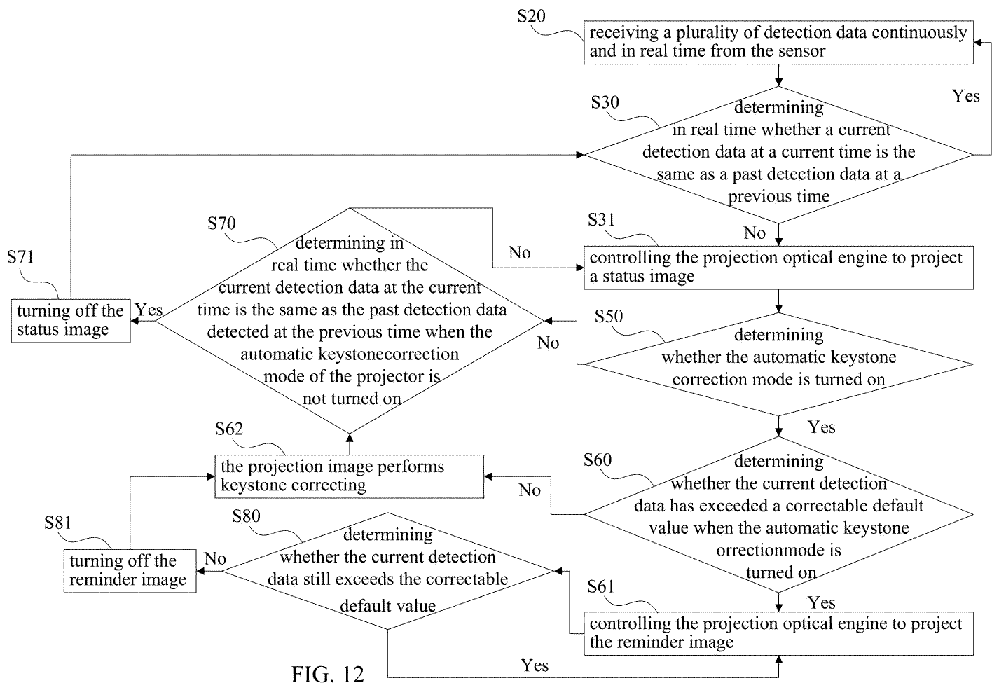

FIG. 12 is a flowchart of the method for assisting the manual adjustment of a projector according to the present disclosure. Refer to FIG. 12 in conjunction with FIG. 1 and FIG. 7. In the aforementioned embodiment, after the controller 13 performs the step of “controlling the projection optical engine 11 to project the status image when the current angle data is different from the past angle data (S31)”, the method further performs the following steps:
determining whether an automatic keystone correction mode is turned on (S50); in the embodiment, the automatic keystone correction mode is a mode in which the projector 10 automatically performs a trapezoidal correction, and the trapezoidal correction adjusts the projection image to a rectangular image. The rectangular image referred to here is a rectangular image with the four corners of the projection image being approximately 90 degrees.
determining whether the current detection data has exceeded a correctable default value when the automatic keystone correction mode is turned on (S60).
controlling the projection optical engine 11 to project a reminder image when the current detection data has exceeded the correctable default value when the automatic keystone correction mode of the projector 10 has been turned on (S61).
determining in real time whether the current detection data at the current time is the same as the past detection data detected at the previous time when the automatic keystone correction mode of the projector 10 is not turned on (S70).
if the automatic keystone correction mode of the projector 10 is not turned on, then when the current detection data is different from the past detection data, the status image continues to be projected (that is, returning to step S31), wherein the status image includes the current detection data.
if the automatic keystone correction mode of the projector 10 is not turned on, then when the current detection data is the same as the past detection data at the previous time, the status image is turned off (S71), and the current detection data and the past detection data at the previous time continue to be determined in real time (that is, returning to step S30).

If the automatic keystone correction mode of the projector 10 is turned on, then when the current detection data does not exceed the correctable default value, the projection image performs keystone correcting (S62), and step S70 is performed.

Please continue to refer to FIG. 12. In the above embodiment, when the controller 13 performs the step of “controlling the projection optical engine 11 to project a reminder image when the current detection data has exceeded the correctable value and the automatic keystone correction mode of the projector 10 has been turned on (S61)”, the method further comprises the following steps:
determining whether the current detection data still exceeds the correctable default value (S80).
when the current detection data still exceeds the correctable default value, continuing to cause the projection optical engine to project the reminder image (that is, return to step S61).
turning off the reminder image when the current detection data does not exceed the correctable default value (S81) and performing the keystone correction on the projection image (that is, perform step S62). In the embodiment, after turning off the reminder image, the controller 13 further performs the keystone correction on the projection image.

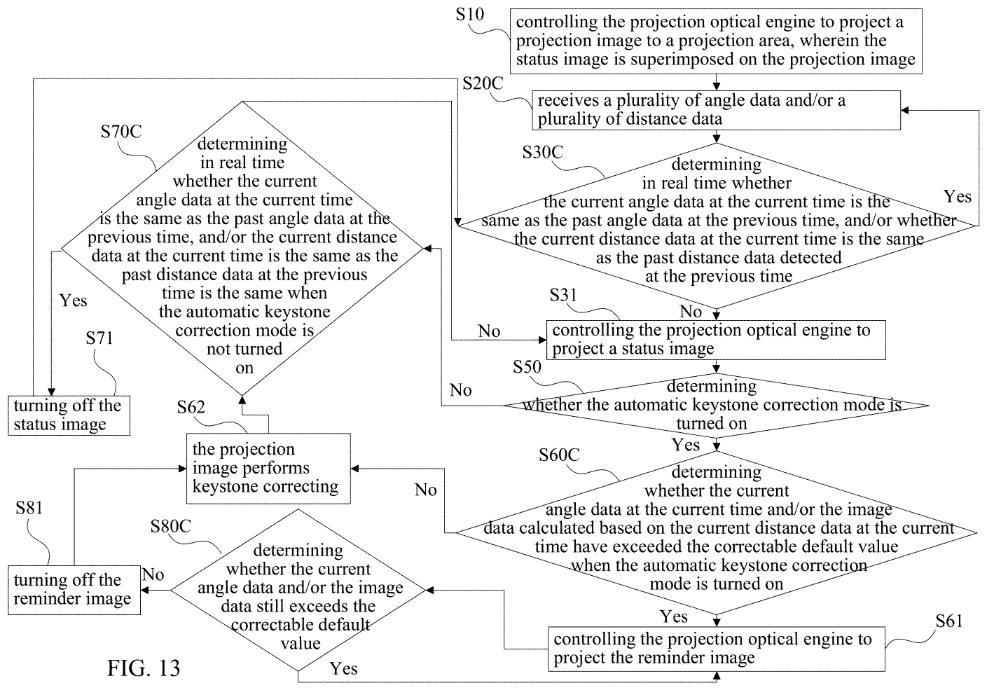

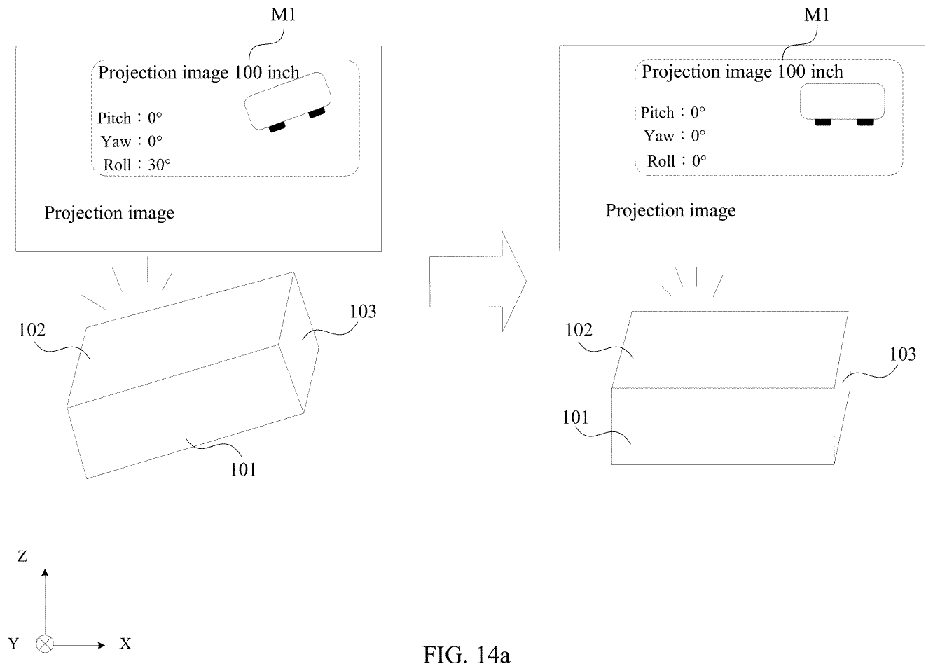

FIG. 13 is a flowchart of a specific method for assisting the manual adjustment of a projector in the present disclosure. Please refer to FIG. 13 and FIG. 2. The sensor 12 in the present embodiment comprises a distance sensor 122 and an inertial sensor 121. The specific method of the present invention comprises the following steps:
controlling the projection optical engine 11 to project a projection image to a projection area, wherein the status image is superimposed on the projection image (S10). In the embodiment, the controller 13 controls the projection optical engine 11 to project a projection image to the projection area.

The controller 13 receives a plurality of angle data and/or a plurality of distance data (S20C). Specifically, the inertial sensor 121 is configured to detect the plurality of angle data of the projector 10, and the distance sensor 122 is configured to detect the plurality of distance data between the projector 10 and the projection image.
determining in real time whether the current angle data at the current time is the same as the past angle data at the previous time, and/or determining in real time whether the current distance data at the current time is the same as the past distance data detected at the previous time (S30C). In the embodiment, when the inertial sensor 121 of the present invention detects the plurality of angle data, the plurality of angle data include the current angle data at the current time and the past angle data at the previous time. The distance sensor 122 detects the plurality of distance data, and the plurality of distance data include the current distance data at the current time and the past distance data at the previous time. The controller 13 determines whether the current angle data at the current time is the same as the past angle data at the previous time, or the controller 13 determines whether the current distance data at the current time is the same as the past distance data at the previous time. Further, the controller 13 determines whether the current angle data at the current time is the same as the past angle data at the previous time, and the controller 13 determines whether the current distance data at the current time is the same as the past distance data at the previous time.

When the current angle data is the same as the past angle data and/or the current distance data is the same as the past distance data, return to step S20C.
controlling the projection optical engine 11 to project a status image when the current angle data is different from the past angle data and/or the current distance data is different from the past distance data (S31). In the embodiment, when the controller 13 determines that the current angle data is different from the past angle data and/or the controller 13 determines that the current distance data is different from the past distance data, the controller 13 controls the projection optical engine 11 to project the status image.
determining whether the automatic keystone correction mode is turned on (S50). In the embodiment, the controller 13 determines whether the automatic keystone correction mode is turned on. For example, a button can be set on the housing of the projector 10. When the button is pressed by the user, the button will transmit a signal to the controller 13, and then the controller 13 can determine that the automatic keystone correction mode is turned on.
determining whether the current angle data at the current time and/or the image data calculated based on the current distance data at the current time have exceeded the correctable default value when the automatic keystone correction mode is turned on (S60C). In the embodiment, when the controller 13 determines that the automatic keystone correction mode is turned on, it further determines whether the current angle data has exceeded the correctable default value or the image data calculated by the controller 13 based on the current distance data, and after the controller 13 calculates the image data, the controller 13 determines whether the image data has exceeded the correctable default value. Further, the controller 13 determines whether the image data calculated based on the current angle data and the current distance data has exceeded the correctable default value. Specifically, the correctable default value is the default in the controller 13, so the controller 13 determines whether the image data calculated based on the current angle data and/or the current distance data has exceeded the correctable default value according to the correctable default value. In the embodiment, the correctable default value is angle data or size information.
controlling the projection optical engine 11 to project a reminder image when the current angle data and/or the image data exceeds the correctable default value (S61). In the embodiment, when the controller 13 determines that the current angle data and/or the image data exceeds the correctable default value, the controller 13 controls the projection optical engine 11 to project the reminder image.
determining whether the current angle data and/or the image data still exceeds the correctable default value (S80C). In the embodiment, after the controller 13 has caused the projection optical engine 11 to project the reminder image, the controller 13 continues to determine whether the current angle data detected at the current time still exceeds the correctable default value and/or the image data calculated by the controller 13 based on the current distance data detected at the current time, and the controller 13 determines whether the image data still exceeds the correctable default value.

When the current angle data and/or image data still exceeds the correctable default value, the projection optical engine 11 continues to be controlled to project the reminder image (that is, return to step S61). In the embodiment, when the controller 13 determines that the current angle data and/or the image data calculated based on the current distance data still exceeds the correctable default value, the controller 13 still controls the projection optical engine 11 to project the reminder image.
turning off the reminder image when the current angle data and/or image data does not exceed the correctable default value (S81) and performs keystone correction to the projection image (S62).
determining in real time whether the current angle data at the current time is the same as the past angle data at the previous time, and/or determining in real time whether the current distance data at the current time is the same as the past distance data at the previous time when the automatic keystone correction mode is not turned on (S70C).
controlling the projection optical engine 11 to project a status image when the current angle data is different from the past angle data and/or the current distance data is different from the past distance data at the previous time; that is, return to step S31.
turning off the status image when the current angle data is the same as the past angle data at the previous time and/or the current distance data is the same as the past distance data at the previous time (S71), and the current angle data at the current time is judged to be the same as the past angle data at the previous time, and/or the current distance data is judged in real time whether the current distance data at the current time is the same as the past distance data at the previous time; that is, return to step S30C.

FIG. 14a is a schematic diagram illustrating an example of the roll angle of the present invention. FIG. 14b is a schematic diagram of the roll angle of FIG. 14a from the same viewing angle. As shown in FIG. 14a, the projector 10 has a first side surface 101, a top surface 102, and a second side surface 103. The inertial sensor 121 detects the current angle data at the current time in the roll direction and the past angle data at the previous time in the roll direction. The controller 13 receives the current angle data and the past angle data in the roll direction from the inertial sensor 12, and the controller 13 determines whether the current angle data is different from the past angle data (in FIG. 14a, the current angle data (as shown on the right side of FIG. 14a) is different from the past angle data (as shown on the left side of FIG. 14a), and the past angle data is shown in FIG. 14b, having a roll angle of 30 degrees). If the current angle data is different from the past angle data, the controller 13 controls the projection optical engine 11 to project the status image as shown in FIG. 14a, and the status image M1 will be superimposed on the projection image. The status image M1 may include an information of the projection image size and an information of a yaw angle Yaw, a pitch angle Pitch and a roll angle Roll. The status image M1 on the left side of FIG. 14a shows that the roll angle Roll is 30 degrees, which represents that the current projector 10 has a roll angle of 30 degrees. The user can rotate the projector 10 around the second coordinate axis Y to adjust the position of the projector 10. In other words, after the user views the result of the status image M1, the user can try to adjust the projector 10 by rolling. It should be noted here that a projector icon in the status image M1 can indicate by color whether the projector 10 has been straightened. For example, the status image M1 on the left side of FIG. 14a currently shows a tilted projector icon, which can be indicated by red. When the user straightens the projector 10, the projector icon in the status image M1 on the right side of FIG. 14a can be indicated by green, which represents that the projector 10 has been straightened.

FIG. 15a is a schematic diagram illustrating an example of the yaw angle of the present invention. FIG. 15b is a schematic diagram of another viewing angle of the yaw angle of FIG. 15a. As shown in FIG. 15a, the projector 10 has a first side surface 101, a top surface 102 and a second side surface 103, as also shown in FIG. 14a. The inertial sensor 121 detects the current angle data at the current time in the yaw direction and the past angle data at the previous time. The controller 13 receives the current angle data and the past angle data in the yaw direction from the inertial sensor 12, and the controller 13 determines whether the current angle data is different from the past angle data (in FIG. 15a, the current angle data (as shown on the right side of FIG. 15a) is different from the past angle data (as shown on the left side of FIG. 15a), and the past angle data is presented in FIG. 15b, with a yaw angle of 25 degrees). If the current angle data is different from the past angle data, the controller 13 will control the projection optical engine 11 to project the status image as shown in FIG. 15a, and the status image M2 will be superimposed on the projection image. The status image M2 also includes the information of the projection image size and the information of the yaw angle Yaw, the pitch angle Pitch, and the roll angle Roll. The status image M2 on the left side of FIG. 15a shows that the yaw angle Yaw is 25 degrees, which represents that the current projector 10 has a yaw angle of 25 degrees. The user can rotate the projector 10 around the third coordinate axis Z to adjust the position of the projector 10. That is to say, after the user views the result of the status image M2, the user can try to adjust the yaw of the projector 10 to straighten the projector 10. It should be noted here that the projector icon in the status image M2 can also use color to indicate whether the projector 10 has been straightened. The implementation method is shown in FIG. 14a, so it will not be repeated.

FIG. 16a is a schematic diagram illustrating an example of the pitch angle of the present invention. FIG. 16b is a schematic diagram of the pitch angle of FIG. 16a from another viewing angle. The projector 10 has a first side surface 101, a top surface 102 and a second side surface 103, as also shown in FIG. 14a. The inertial sensor 121 detects the current angle data at the current time in the pitch direction and the past angle data at the previous time in the pitch direction. The controller 13 receives the current angle data and the past angle data in the pitch direction from the inertial sensor 12, and the controller 13 determines whether the current angle data is different from the past angle data (in FIG. 16a, the current angle data (as shown on the right side of FIG. 16a) is different from the past angle data (as shown on the left side of FIG. 16a), and the past angle data is presented in FIG. 16b, with a pitch angle of 45 degrees). If the current angle data is different from the past angle data, the controller 13 controls the projection optical engine 11 to project the status image as shown in FIG. 16a, and the status image M3 will be superimposed on the projection image. The status image M3 also includes the information of the projection image size and the information of the yaw angle Yaw, the pitch angle Pitch, and the roll angle Roll. The status image M3 on the left side of FIG. 16a shows that the pitch angle Pitch is 45 degrees, which represents that the current projector 10 has a pitch angle of 45 degrees. The user can rotate the projector 10 around the first coordinate axis X to adjust the position of the projector 10. That is to say, after the user views the result of the status image M3, the user can try to adjust the pitch of the projector 10 to straighten the projector 10. It should be noted here that the projector icon in the status image M3 can also use color to indicate whether the projector 10 has been straightened. The implementation method is shown in FIG. 14a, so it will not be repeated.

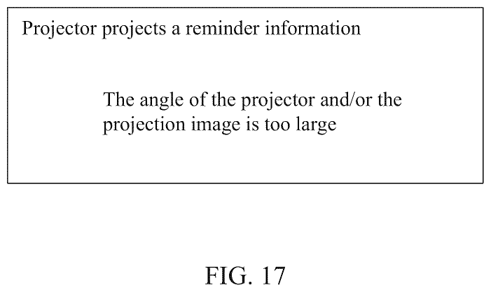

FIG. 17 is a schematic diagram of the reminder image mentioned in FIG. 12 and FIG. 13. As shown in FIG. 17, when the controller 13 determines that the current detection data has exceeded the correctable default value in the controller 13, the controller 13 controls the projection optical engine 11 to project the reminder image so as to project a reminder information through the projector 10 and remind the user that the angle of the projector 10 and/or the projection image is too large.

In summary, the method and projector for assisting the manual adjustment of the projector according to the embodiment of the present invention have at least one of the following advantages. When the controller determines that the current detection data is different from the past detection data, the controller controls the projection optical engine to project the status image to provide the user with the assistance of the status image to adjust the positions of the projector such that the user can adjust the projector while checking the information on the status image to confirm whether the image has been straightened. In this way, the user does not need to move to a specific viewing point after each adjustment of the projector in order to fully see the effect of the projection image and then adjust the position of the projector again, thereby improving the convenience and efficiency of operation.

It should be noted that, in this article, term “comprises”, “comprises” or its any other variant are intended to contain non-exclusive comprising, thereby make the process, method, article or device that comprise a series of key elements not only comprise those key elements, but also comprise other key elements that are not clearly listed, or also comprise the key element that is intrinsic to this process, method, article or device. In the situation that there is no more restriction, the key element limited by statement “comprises one . . . ”, does not exclude that in the process, method, article or device that comprise this key element, also have other identical key element.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A method for assisting the manual adjustment of a projector, the projector comprising a projection optical engine, a sensor and a controller, the controller being coupled to the projection optical engine and the sensor, and the method being performed by the controller, the method comprising:
receiving a plurality of detection data continuously and in real time from the sensor;
determining in real time whether a current detection data at a current time is the same as a past detection data at a previous time, wherein the plurality of detection data comprise the current detection data and the past detection data;
controlling the projection optical engine to project a status image when the current detection data is different from the past detection data, wherein the status image comprises a current angle data and the current angle data is obtained based on the plurality of detection data; and
not controlling the projection optical engine to project the status image when the current detection data is the same as the past detection data.

2. The method for assisting the manual adjustment of a projector as claimed in claim 1, wherein before the step of receiving a plurality of detection data continuously and in real time from the sensor, the method comprises the following step:
controlling the projection optical engine to project a projection image to a projection area, wherein the status image is superimposed on the projection image.

3. The method for assisting the manual adjustment of a projector as claimed in claim 1, wherein the current angle data comprises a first angle data and a second angle data, and the first angle data and the second angle data are orthogonal to each other.

4. The method for assisting the manual adjustment of a projector as claimed in claim 3, wherein the current angle data further comprises a third angle data, and the first angle data, the second angle data and the third angle data are orthogonal to each other.

5. The method for assisting the manual adjustment of a projector as claimed in claim 1, wherein the sensor comprises an inertial sensor, the plurality of detection data comprise a plurality of angle data detected by the inertial sensor, the current detection data comprises the current angle data detected by the inertial sensor at the current time, and the past detection data comprises the past angle data detected by the inertial sensor at the previous time, and after the step of controlling the projection optical engine to project the status image, the method further comprises the following steps:
determining in real time whether the current angle data received at the current time is the same as the past angle data received at the previous time;
continuing to project the status image when the current angle data is different from the past angle data, wherein the status image includes the current angle data; and
turning off the status image when the current angle data is the same as the past angle data and continuing to determine in real time whether the current angle data is the same as the past angle data.

6. The method for assisting the manual adjustment of a projector as claimed in claim 1, wherein the sensor comprises a distance sensor, the plurality of detection data comprise a plurality of distance data detected by the distance sensor, the current detection data comprises the current distance data detected by the distance sensor at the current time, and the past detection data comprises the past distance data detected by the distance sensor at the previous time, and after the step of controlling the projection optical engine to project the status image, the method further comprises the following steps:
determining in real time whether the current distance data received at the current time is the same as the past distance data received at the previous time;
continuing to project the status image when the current distance data is different from the past distance data, wherein the status image comprises the current angle data and the current angle data is obtained by calculation based on the current distance data and the past distance data; and
turning off the status image when the current distance data is the same as the past distance data and continuing to determine in real time whether the current distance data is the same as the past distance data.

7. The method for assisting the manual adjustment of a projector as claimed in claim 1, wherein the sensor comprises a distance sensor, the current detection data comprises the current distance data detected by the distance sensor at the current time, and the method further comprises the following steps:
calculating a current size information of a projection image according to the current distance data at the current time; and
controlling the projection optical engine to project the status image, wherein the status image includes the current size information of the projection image.

8. The method for assisting the manual adjustment of a projector as claimed in claim 1, wherein after the step of controlling the projection optical engine to project the status image, the method comprises the following steps:
determining whether an automatic keystone correction mode is turned on;
determining whether the current detection data exceeds a correctable default value when the automatic keystone correction mode is turned on; and
controlling the projection optical engine to project a reminder image when the current detection data exceeds the correctable default value.

9. The method for assisting the manual adjustment of a projector as claimed in claim 8, wherein after the step of controlling the projection optical engine to project a reminder image, the method comprises the following steps:
determining whether the current detection data still exceeds the correctable default value;
continuing to control the projection optical engine to project the reminder image when the current detection data still exceeds the correctable default value; and
turning off the reminder image and performing a keystone correction when the current detection data does not exceed the correctable default value.

10. The method for assisting the manual adjustment of a projector as claimed in claim 8, wherein after the step of determining whether the automatic keystone correction mode is turned on, the method further comprises the following steps:
determining in real time whether the current detection data at the current time is the same as the past detection data at the previous time when the automatic keystone correction mode of the projector is not turned on;
continuing to project the status image when the current detection data is different from the past detection data at the previous time, wherein the status image includes the current detection data; and
turning off the status image when the current detection data is the same as the past detection data at the previous time and continuing to determine in real time whether the current detection data is the same as the past detection data at the previous time.

11. The method for assisting the manual adjustment of a projector as claimed in claim 1, wherein the sensor comprises an inertial sensor and a distance sensor, the plurality of detection data comprises a plurality of angle data detected by the inertial sensor and/or a plurality of distance data detected by the distance sensor, the current detection data comprises the current angle data detected by the inertial sensor at the current time and/or the current distance data detected by the distance sensor at the current time, and the past detection data comprises the past angle data detected by the inertial sensor at the previous time and/or the past distance data detected by the distance sensor at the previous time, and after receiving the plurality of angle data and/or the plurality of distance data, the method comprises the following steps:
determining in real time whether the current angle data at the current time is the same as the past angle data at the previous time and/or determining in real time whether the current distance data at the current time is the same as the past distance data detected at the previous time;
controlling the projection optical engine to project the status image when the current angle data is different from the past angle data and/or the current distance data is different from the past distance data;
determining whether an automatic keystone correction mode is turned on;
determining whether the current angle data at the current time and/or the image data calculated based on the current distance data at the current time has exceeded a correctable default value when the automatic keystone correction mode is turned on; and
controlling the projection optical engine to project a reminder image when the current angle data and/or the image data have exceeded the correctable default value.

12. The method for assisting the manual adjustment of a projector as claimed in claim 11, wherein after the step of the projection optical engine projecting the reminder image, the method comprises the following steps:
determining whether the current angle data and/or the image data still exceeds the correctable default value;
continuing to control the projection optical engine to project the reminder image when the current angle data and/or the image data still exceeds the correctable default value; and
turning off the reminder image and performing the keystone correction when the current angle data and/or the image data do not exceed the correctable default value.

13. The method for assisting the manual adjustment of a projector as claimed in claim 11, wherein when the automatic keystone correction mode of the projector is not turned on, the method further comprises the following steps:
determining in real time whether the current angle data at the current time is the same as the past angle data detected at the previous time, and/or determining in real time whether the current distance data at the current time is the same as the past distance data detected at the previous time;
controlling the projection optical engine to project the status image when the current angle data is different from the past angle data at the previous time and/or the current distance data is different from the past distance data at the previous time; and
turning off the status image when the current angle data is the same as the past angle data at the previous time and/or the current distance data is the same as the past distance data at the previous time, and continuing to determine whether the current angle data at the current time is the same as the past angle data at the previous time, and/or determining in real time whether the current distance data at the current time is the same as the past distance data at the previous time.

14. The method for assisting the manual adjustment of a projector as claimed in claim 11, wherein before receiving the plurality of distance data and/or the plurality of angle data, the method comprises the following step:
controlling the projection optical engine to project a projection image to a projection area, wherein the status image is superimposed on the projection image.

15. A projector, comprising a projection optical engine, a sensor and a controller, wherein:
the sensor is used to continuously and in real time transmit a plurality of detection data to the controller;
the controller is electrically connected to the projection optical engine and the sensor, and the controller is configured to perform:
receiving continuously and in real time the plurality of detection data detected by the sensor;
determining in real time whether a current detection data at a current time is the same as a past detection data at a previous time, wherein the plurality of detection data include the current detection data and the past detection data;
controlling the projection optical engine to project a status image when the current detection data is different from the past detection data, wherein the status image includes a current angle data and the current angle data is obtained based on the plurality of detection data; and
not controlling the projection optical engine to project the status image when the current detection data is the same as the past detection data.

16. The projector as claimed in claim 15, wherein before the controller receives continuously and in real time the plurality of detection data detected by the sensor, the controller is further configured to perform:
controlling the projection optical engine to project a projection image to a projection area, wherein the status image is superimposed on the projection image.

17. The projector as claimed in claim 15, wherein the current angle data comprises a first angle data and a second angle data, and the first angle data and the second angle data are orthogonal to each other.

18. The projector as claimed in claim 17, wherein the current angle data further comprises a third angle data, and the first angle data, the second angle data and the third angle data are orthogonal to each other.

19. The projector as claimed in claim 15, wherein the sensor comprises an inertial sensor, the plurality of detection data corresponds to a plurality of angle data detected by the inertial sensor, the current detection data corresponds to the current angle data detected by the inertial sensor at the current time, and the past detection data corresponds to the past angle data detected by the inertial sensor at the previous time, and after the controller controls the projection optical engine to project the status image, the controller is further configured to perform:
determining in real time whether the current angle data received at the current time is the same as the past angle data received at the previous time;
continuing to project the status image when the current angle data is different from the past angle data, wherein the status image includes the current angle data; and
turning off the status image when the current angle data is the same as the past angle data and continuing to determine in real time whether the current angle data is the same as the past angle data.

20. The projector as claimed in claim 15, wherein the sensor comprises a distance sensor, the plurality of detection data correspond to a plurality of distance data detected by the distance sensor, the current detection data corresponds to the current distance data detected by the distance sensor at the current time, and the past detection data corresponds to the past distance data detected by the distance sensor at the previous time, and after the controller controls the projection optical engine to project the status image, the controller is further configured to perform:
determining in real time whether the current distance data received at the current time is the same as the past distance data received at the previous time;
continuing to project the status image when the current distance data is different from the past distance data, wherein the status image comprises the current angle data obtained by calculation based on the current distance data and the past distance data; and
turning off the status image when the current distance data is the same as the past distance data and continuing to determine in real time whether the current distance data is the same as the past distance data.

21. The projector as claimed in claim 15, wherein the sensor comprises a distance sensor, the current detection data corresponds to the current distance data detected by the distance sensor at the current time, and the controller is further configured to perform:
calculating a current size information of a projection image according to the current distance data; and
controlling the projection optical engine to project the status image, wherein the status image includes the current size information of the projection image.

22. The projector as claimed in claim 15, wherein after the controller controls the projection optical engine to project the status image, the controller is further configured to perform:
determining whether an automatic keystone correction mode is turned on;
determining whether the current detection data has exceeded a correctable default value when the automatic deformation correction mode is turned on; and
controlling the projection optical engine to project a reminder image when the current detection data has exceeded the correctable default value.

23. The projector as claimed in claim 22, wherein after the projection optical engine projects a reminder image, the controller is further configured to perform:
determining whether the current detection data still exceeds the correctable default value;
continuing to control the projection optical engine to project the reminder image when the current detection data still exceeds the correctable default value; and
turning off the reminder image and performing a keystone correction when the current detection data does not exceed the correctable default value.

24. The projector as claimed in claim 22, wherein after determining whether the automatic keystone correction mode is turned on, the controller is further configured to perform:
determining in real time whether the current detection data at the current time is the same as the past detection data at the previous time when the automatic keystone correction mode of the projector is not turned on;
continuing to project the status image when the current detection data is different from the past detection data at the previous time, wherein the status image includes the current detection data; and
turning off the status image when the current detection data is the same as the past detection data and continuing to determine in real time whether the current detection data is the same as the past detection data at the previous time.

25. The projector as claimed in claim 15, wherein the projection optical engine projects a projection image on a projection area, the sensor comprises an inertial sensor and a distance sensor, the current detection data comprises the current angle data detected by the inertial sensor at the current time and/or the current distance data detected by the distance sensor at the current time, and the past detection data comprises the past angle data detected by the inertial sensor at the previous time and/or the past distance data detected by the distance sensor at the previous time, and after the controller receives a plurality of distance data and/or the plurality of angle data, the controller is configured to perform:
determining in real time whether the current angle data at the current time is the same as the past angle data detected at the previous time and/or determining in real time whether the current distance data at the current time is the same as the past distance data detected at the previous time;
controlling the projection optical engine to project the status image when the current angle data is different from the past angle data and/or the current distance data is different from the past distance data;
determining whether an automatic keystone correction mode is turned on;
determining whether the current angle data and/or the image data calculated based on the current distance data at the current time have exceeded a correctable default value when the automatic deformation correction mode is turned on; and
controlling the projection optical engine to project a reminder image when the current angle data and/or the image data have exceeded the correctable default value.

26. The projector as claimed in claim 25, wherein after the projection optical engine projects the reminder image, the controller is further configured to perform:
determining whether the current angle data and/or the image data still exceeds the correctable default value;
continuing to control the projection optical engine to project the reminder image when the current angle data and/or the image data still exceeds the correctable default value; and
turning off the reminder image and performing a keystone correction when the current angle data and/or the image data do not exceed the correctable default value.

27. The projector as claimed in claim 25, wherein when the automatic keystone correction mode of the projector is not turned on, the controller is further configured to perform:
determining in real time whether the current angle data at the current time is the same as the past angle data detected at the previous time, and/or determining in real time whether the current distance data at the current time is the same as the past distance data detected at the previous time;
controlling the projection optical engine to project the status image when the current angle data is different from the past angle data at the previous time and/or the current distance data is different from the past distance data at the previous time; and
turning off the status image when the current angle data is the same as the past angle data at the previous time and/or the current distance data is the same as the past distance data at the previous time and continuing to determine whether the current angle data at the current time is the same as the past angle data at the previous time, and/or determining in real time whether the current distance data at the current time is the same as the past distance data at the previous time.

28. The projector as claimed in claim 25, wherein before the controller receives the plurality of distance data and/or the plurality of angle data, the controller is configured to perform:
controlling the projection optical engine to project the projection image to the projection area, wherein the status image is superimposed on the projection image.
